(19) United States
(12) Patent Application Publication
(10) Pub. No.: US 2002/0157721 A1
(43) Pub. Date: Oct. 31, 2002

(54) Sheath pipe, sheath pipe manufacturing method, and sheath pipe manufacturing apparatus

(76) Inventor: Shinnosuke Hirano, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/009,515

(22) PCT Filed: Apr. 19, 2001
(86) PCT No.: PCT/JP01/03364

(30) Foreign Application Priority Data
Apr. 20, 2000 (JP) 2000-119813

(51) Int. Cl. F16L 11/00

(52) U.S. Cl. 138/129; 138/130

(57) ABSTRACT

By a sheath tube manufacturing apparatus comprising a wrapping section (20a) having a core (21a) for wrapping a single ribbon-like member (10a) having a predetermined width thereon, a member supply section (40a) for supplying the ribbon-like member at a predetermined angle, so that the ribbon-like member is wrapped spirally, with the end thereof overlapped, a rotation section (30a) for rotating the wrapping section (20a), a welding section (50a) for fusing and pressing the overlapped portion of the ribbon-like member wrapped around the wrapping section, and a member delivery section (60a) for pressing the fused overlapped portion and delivering it from the core, the single ribbon-like member having a predetermined width is wrapped spirally, with the end thereof overlapped, and this overlapped portion is welded to be formed in a cylindrical shape.

### TECHNICAL FIELD

The present invention relates to a sheath tube, and a method and apparatus for manufacturing this sheath tube. More specifically, the present invention relates to a sheath tube, which is formed in a cylindrical shape by spirally wrapping a single ribbon-like member having a predetermined width, with the end of the ribbon-like member being overlapped, and by welding this overlapped portion, and a method and apparatus for manufacturing this sheath tube.

### BACKGROUND ART

In the related art, sheath tubes made of a synthetic resin or the like have been manufactured as a predetermined lengthy tube by an apparatus using an extrusion molding or injection molding method, and various machining is performed, such as cutting or enlarging the tip portion thereof, in order to join these to make a predetermined length.

Moreover, as another method, there is disclosed “A cable armor having a multi-layer structure, a manufacturing method of the armor and a machine for performing the method” (Japanese Patent 11-508005T).

According to this, an armor (sheath tube) is manufactured by a method and apparatus for manufacturing the armor, wherein a multilayer structure comprising at least two overlapping plastic material layers is included, each layer comprising a strip, and these strips are arranged spirally with the side edges thereof being brought into contact with each other, and sealed together.

With a conventional manufacturing method, however, at the time of manufacturing a sheath tube having a different diameter, the manufacturing apparatus, a mold and the like have to be changed, thereby causing problems of a cost increase and longer time required.

Taking into consideration storage and transportation of the manufactured sheath tubes, the length thereof is naturally limited, and in order to make a sheath tube having a desired length, an operation for joining several sheath tubes at the site is required. Therefore, there is another problem in that a separate step becomes necessary, such as machining the tip portion of the sheath tube for joining.

On the other hand, according to the method disclosed in Japanese Patent 11-508005T described above, a plurality of, at least two strips (corresponding to a ribbon-like member in the present invention) has to be used for manufacturing, and when a plurality of strips is used, the apparatus needs to be improved for overlapping the strips on each other.

Therefore, there is a problem to be solved for providing a method and apparatus which can easily manufacture sheath tubes having a desired diameter and length, for example, at the site.

### DISCLOSURE OF INVENTION

For solving the above problems, the sheath tube, the sheath tube manufacturing method and the sheath tube manufacturing apparatus according to the present invention have constructions as described below.

(1) A sheath tube formed in a cylindrical shape, in such a manner that a single ribbon-like member having a predetermined width is wrapped spirally, with the end thereof overlapped, and the overlapped portion is welded.

(2) The sheath tube of (1), wherein the ribbon-like member has at least two walls provided parallel with the longitudinal direction thereof, and is wrapped spirally, with the outside end portions of the walls overlapped, and the overlapped portion between the walls are welded to be formed in a cylindrical shape.

(3) The sheath tube of (1) or (2), wherein the ribbon-like member is formed of a thermoplastic synthetic resin (for example, high density polyethylene).

(4) The sheath tube of (3), wherein the thermoplastic synthetic resin is transparent or semi-transparent.

(5) A sheath tube manufacturing method wherein a single ribbon-like member having a predetermined width is wrapped spirally, with the end thereof overlapped, and the overlapped portion is welded, to thereby form a sheath tube in a cylindrical shape.

(6) The sheath tube manufacturing method of (5), wherein the ribbon-like member has at least two walls provided parallel with the longitudinal direction thereof, and is wrapped spirally, with the outside end portions of the walls overlapped, and the overlapped portion of the outside end portions of the walls are welded, to form a sheath tube in a cylindrical shape.

(7) The sheath tube manufacturing method of (5) or (6), wherein the overlapped portion of the ribbon-like member is heated and wrapped.

(8) The sheath tube manufacturing method of (5), (6) or (7), wherein the ribbon-like member is formed of a thermoplastic synthetic resin (for example, high density polyethylene).

(9) The sheath tube manufacturing method of (8), wherein the thermoplastic synthetic resin is transparent or semi-transparent.

(10) A sheath tube manufacturing apparatus comprising: a wrapping section having a core for wrapping a ribbon-like member having a single predetermined width thereon; a member supply section for supplying the ribbon-like member at a predetermined angle, so that the ribbon-like member are wrapped spirally, with the end thereof overlapped; a rotation section for rotating the wrapping section; a welding section for fusing and pressing the overlapped portion of the ribbon-like member wrapped around the wrapping section; and a member delivery section for pressing the fused overlapped portion and delivering it from the core.

(11) The sheath tube manufacturing apparatus of (10), wherein the member supply section is provided with heating means for heating the whole wrapped portion of the ribbon-like member, when the ribbon-like member is wrapped around the wrapping section.

(12) The sheath tube manufacturing apparatus of (10) or (11), wherein the ribbon-like member is formed of a thermoplastic synthetic resin (for example, high-density polyethylene).

(13) The sheath tube manufacturing apparatus of (12), wherein the thermoplastic synthetic resin is transparent or semi-transparent.

By this sheath tube, the sheath tube manufacturing method and the sheath tube manufacturing apparatus, the ribbon-like member is wrapped spirally so that the end portions or the walls thereof are overlapped at a predetermined angle, and the overlapped portion is welded to thereby form a sheath tube in a cylindrical shape. As a result, a manufacturing method of the sheath tube becomes easy, and the process thereof can be also simplified.

### BRIEF DESCRIPTION OF DRAWINGS

FIG. 1 is a diagram showing the situation when a ribbon-like member is attached to and wrapped around a sheath tube manufacturing apparatus in a first embodiment of the present invention;

FIG. 2 is a diagram showing the situation when a ribbon-like member is wrapped and welded on a core of the sheath tube manufacturing apparatus in the first embodiment of the present invention;

FIG. 3 is a diagram showing the situation when a ribbon-like member having two walls is attached to and wrapped around a sheath tube manufacturing apparatus in a second embodiment of the present invention;

FIG. 4 is a diagram for explaining the ribbon-like member having two walls, used in the second embodiment of the present invention;

FIG. 5 is a diagram for explaining a member supply section in the sheath tube manufacturing apparatus in the second embodiment of the present invention;

FIG. 6 is a side view of the member supply section in the sheath tube manufacturing apparatus in the second embodiment of the present invention;

FIG. 7 is a diagram for explaining the condition when a ribbon-like member is inserted between a pressing roller in a welding section and a core in a wrapping section of the sheath tube manufacturing apparatus and pressed, in the second embodiment of the present invention;

FIG. 8 is a diagram for explaining the condition when the ribbon-like member having walls is wrapped and welded on the core of the sheath tube manufacturing apparatus in the second embodiment of the present invention; and

FIG. 9 is a diagram of a member delivery section of the sheath tube manufacturing apparatus in the second embodiment of the present invention.

### BEST MODE FOR CARRYING OUT THE INVENTION

Next, embodiments of the sheath tube, the sheath tube manufacturing method and the sheath tube manufacturing apparatus according to the present invention will be described, with reference to the drawings.

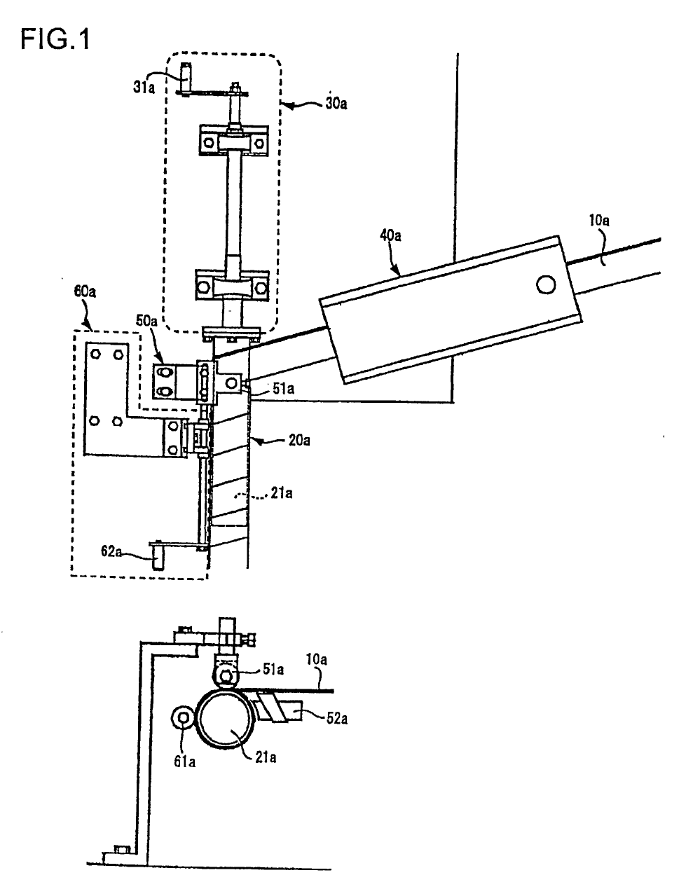

The sheath tube manufacturing apparatus for realizing the sheath tube manufacturing method in a first embodiment according to the present invention comprises, as shown in FIG. 1: a wrapping section 20a having a cylindrical core 21a for wrapping a ribbon-like member 10a formed of high density polyethylene; a rotation section 30a coupled to this wrapping section 20a with a flange joint, and having a handle 31a for rotating the core 21a for wrapping the ribbon-like member 10a; a preheater (not shown) arranged on the side of the wrapping section 20a for softening the ribbon-like member 10a; a member supply section 40a having a guide (not shown) for deciding the position of the ribbon-like member 10a, for supplying the ribbon-like member 10a at a predetermined angle so that the ribbon-like member 10a is wrapped spirally around the wrapping section 20a, with the end portion thereof overlapped; a welding section 50a disposed on the side of the wrapping section 20a for welding the overlapped portion; and a member delivery section 60a arranged in the vicinity of the tip portion of the core 21a for pressing the welded overlapped portion and delivering it.

Here, the handler 31a in the rotation section 30a has a construction of being rotated manually, but the construction is not limited thereto, and needless to say, the construction may be such that a motor or the like may be attached so as to rotate automatically or by automatic control.

If the ribbon-like member 10a is formed of transparent or semi-transparent high-density polyethylene, the situation within the tube can be confirmed visually, after the sheath tube has been prepared.

The welding section 50a is constructed such that it comprises a pressing roller 51a for wrapping the ribbon-like member 10a supplied from the member supply section 40a on the core 21a, while pressing the overlapped end portion of the ribbon-like member 10a, and a fusing heater 52a for fusing the overlapped portion.

The member delivery section 60a has a knurled roller 61a having subjected to knurling for rotating the ribbon-like member 10a formed in a cylindrical shape and delivering it from the core 21a, and a handle 62a for rotating the knurled roller 61a. Here, the construction is such that the handle 62a for rotating the knurled roller 61a is provided for manually rotating it, but the construction is not limited thereto, and needless to say, the construction may be such that a motor or the like may be attached so as to rotate it automatically or by automatic control.

A method for manufacturing sheath tubes, using a single ribbon-like member made of a synthetic resin having a predetermined width, by the sheath tube manufacturing apparatus having such a construction will now be described.

At first, a single ribbon-like member 10a formed of high density polyethylene having a predetermined width is pulled out from a drum or the like (not shown), and inserted into the member supply section 40a along a guide (not shown). The inserted ribbon-like member 10a is inserted at an angle so as to be wrapped spirally, and preheated by a preheater (not shown) so that it can be easily wrapped on the core 21a in the wrapping section 20a, and the ribbon-like member 10a is inserted between the core 21a and the pressing roller 51a in the welding section 50a, in the softened state.

Then, when the handle 31a in the rotation section 30a is rotated, the core 21a in the wrapping section 20a rotates, and the ribbon-like member 10a is drawn and wrapped on the core 21a spirally, so that the end portion thereof is overlapped.

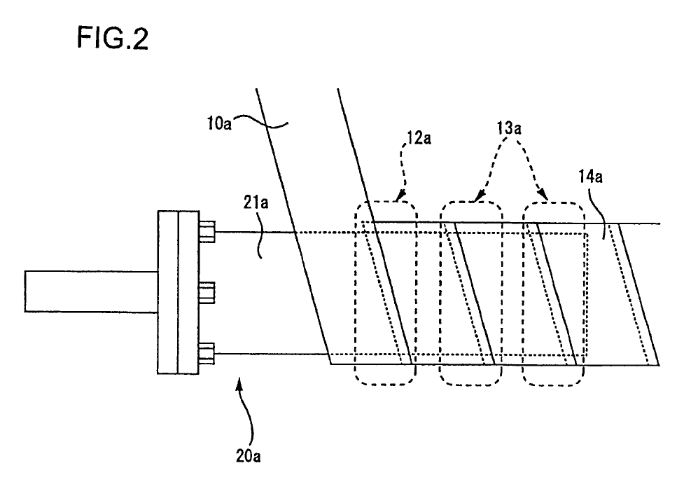

The welding section 50a presses the overlapped portion 12a of the ribbon-like member 10a shown in FIG. 2 by a pressing roller 51, while rotating the core 21a, to thereby wrap it on the core 21a, and the overlapped portion 12a is heated by a fusing heater 52a (see FIG. 1(B)) and fused.

Subsequently, when the handle 62a of the member delivery section 60a is rotated, the fused overlapped portion 12a is pressed by the knurled roller 61a (see FIG. 1(B)), being a pressing roller, and completely welded.

When the handle 62a is further rotated, the overlapped portion 13a which is cooled after having been welded and cured in a cylindrical shape is delivered from the core 21a, thereby the sheath tube 14a is manufactured.

By repeating this, the sheath tube having a desired length is manufactured. The core 21a in the wrapping section 20a is replaceable, since it is connected by the flange joint, and by replacing it with a core having another diameter, a sheath tube having a desired inner diameter can be manufactured.

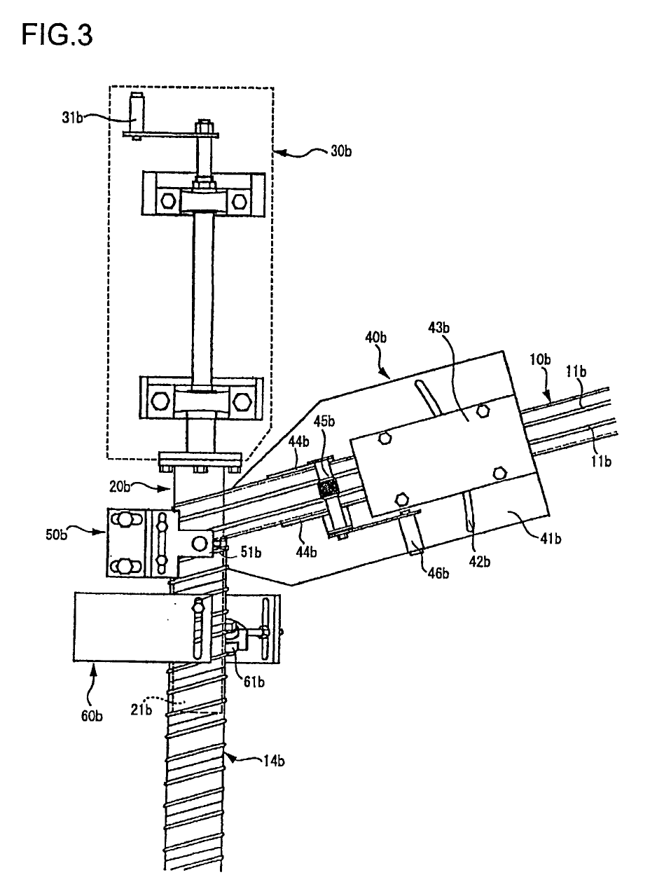

As a second embodiment, the sheath tube manufacturing apparatus shown in FIG. 3 comprises: a wrapping section 20b having a cylindrical core 21b for wrapping a ribbon-like member 10b formed of high density polyethylene; a rotation section 30b coupled to this wrapping section 20b with a flange joint, and having a handle 31b for rotating the core 21b for wrapping the ribbon-like member 10b; a preheater 43b arranged at a position that can supply the ribbon-like member 10b to the wrapping section 20b at a predetermined angle, for softening the ribbon-like member 10b on an adjustment stand 41b provided with an adjustment groove 42b for adjusting the supply angle of the ribbon-like member 10b; a guide 44b for determining the position of the ribbon-like member 10b; a supply roller 45b having subjected to knurling for clamping the ribbon-like member 10b from the front and back faces thereof to deliver it to the wrapping section 20b; a member supply section 40b provided with a handle 46b connected to the supply roller 45b to rotate the supply roller 45b; a pressing roller 51b installed on the side of the wrapping section 20b, for wrapping the ribbon-like member 10a supplied from the member supply section 40b on the core 21b in the wrapping section 20b, while pressing the overlapped portion of the ribbon-like member 10b; a welding section 50b having a fusing heater (not shown) for fusing the overlapped portion; and a member delivery section 60b having a knurled roller 61b arranged in the vicinity of the tip portion of the core 21b and having subjected to knurling for pressing the fused overlapped portion, rotating the cylindrical ribbon-like member 10b and delivering it from the core 21b.

A method for manufacturing sheath tubes, using a single ribbon-like member made of a synthetic resin having a predetermined width, with two walls parallel with each other in the longitudinal direction, by the sheath tube manufacturing apparatus having such a construction will now be described. The ribbon-like member used in this sheath tube manufacturing apparatus may not have walls, and in the case where it has walls, the number thereof is not limited thereto, so long as there are at least two.

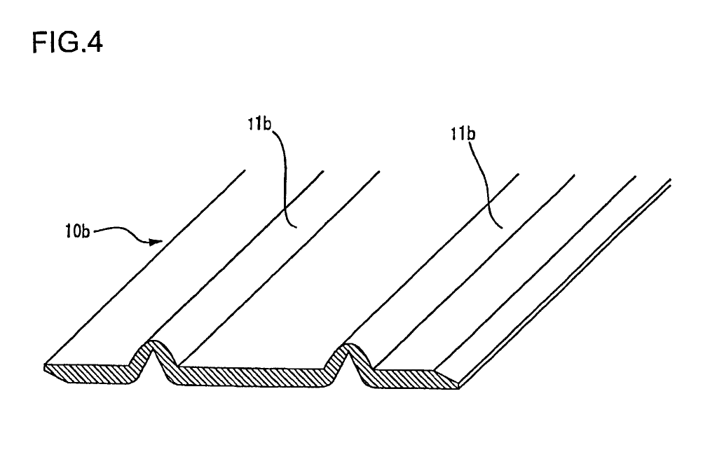

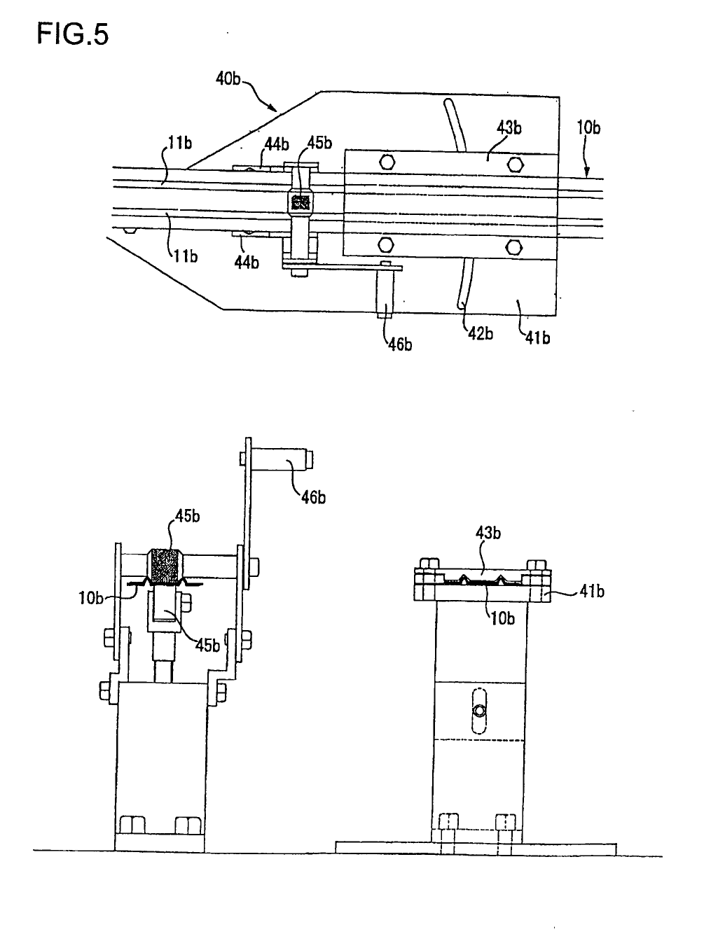

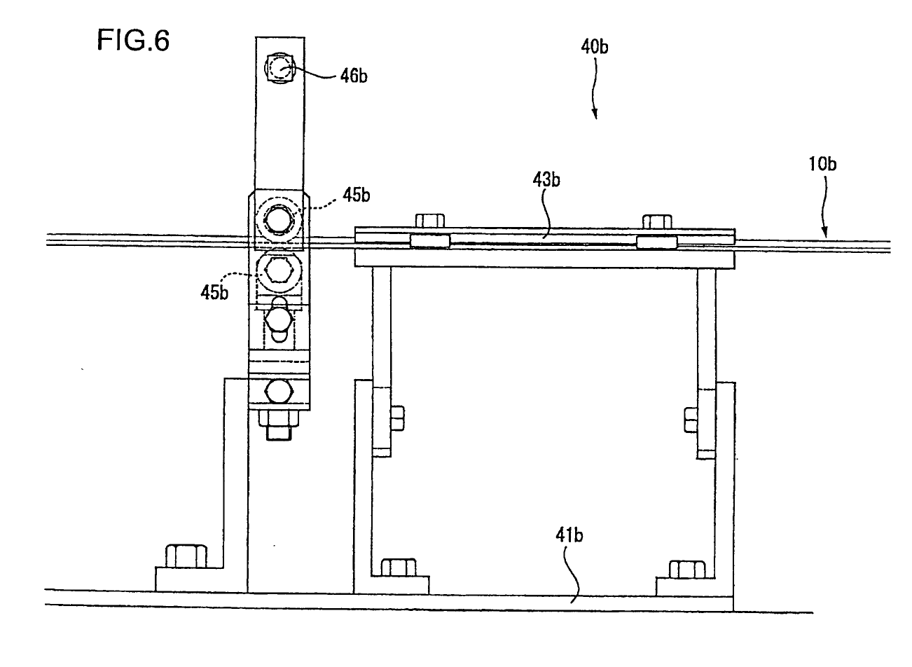

At first, as shown in FIG. 4, a single ribbon-like member 10b made of a synthetic resin having a predetermined width, with two walls 11b parallel with each other in the longitudinal direction, and wrapped around a drum (not shown), is pulled out, and inserted into the member supply section 40b shown in FIG. 5 and FIG. 6. The inserted ribbon-like member 10b is inserted at an angle so as to be wrapped spirally, with the walls 11b being overlapped, and preheated by a preheater 43b so that it can be easily wrapped on the core 21b, and the ribbon-like member 10a becomes a softened state.

The angle for supplying the ribbon-like member 10b to the wrapping section 20b is further adjusted by the adjustment groove 42b on the adjustment stand 41b, or the angle of supplying the ribbon-like member 10a is changed, at the time of manufacturing a sheath tube having a different inner diameter.

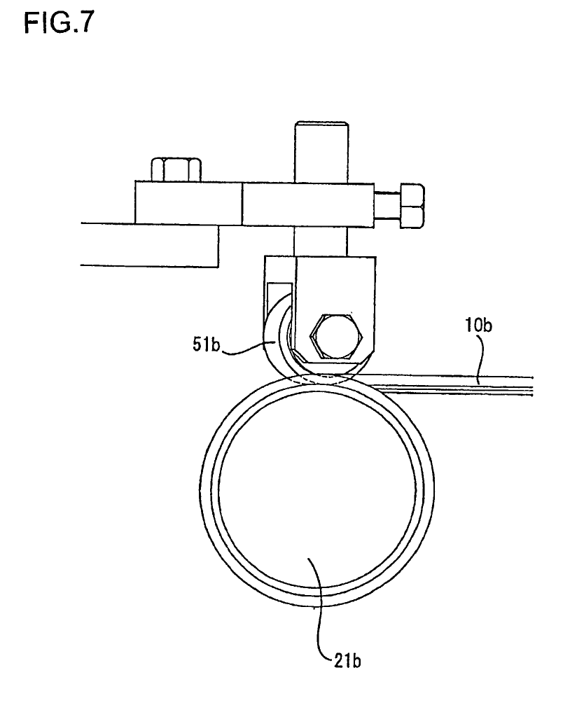

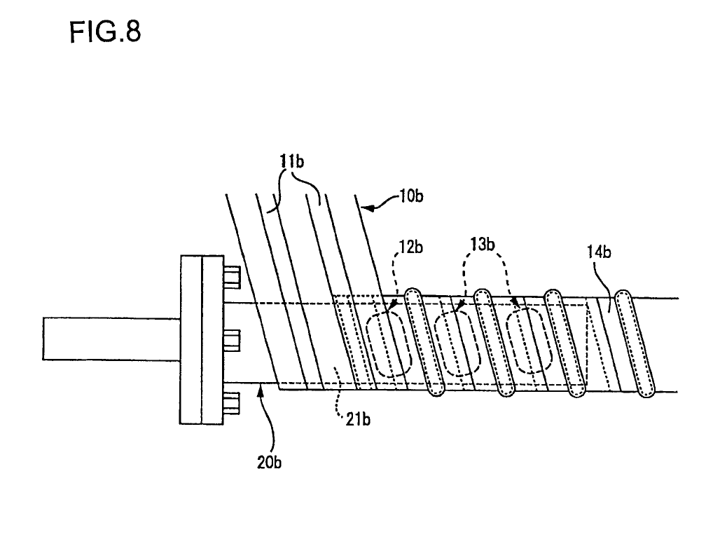

The softened ribbon-like member 10b is inserted between the upper and lower supply rollers 45b shown in FIG. 5, and by rotating the handle 46b, the ribbon-like member 10b is delivered so as to be inserted between the core 21b (see FIG. 3) in the wrapping section 20b installed ahead thereof and the pressing roller 51b (see FIG. 3) in the welding section 50b. Subsequently, when the handle 31b in the rotation section 30b is rotated, the core 21b in the wrapping section 20b connected by the flange joint rotates, and as shown in FIG. 7, the ribbon-like member 10b inserted between the core 21b and the pressing roller 51b is wrapped on the core 21b spirally, with the walls 11b being overlapped (see FIG. 8).

The welding section 50b shown in FIG. 3 presses the overlapped portion 12b of the ribbon-like member 10b by the pressing roller 50b (see FIG. 7), so as to heat and fuse this pressed overlapped portion 12b by a fusing heater (not shown).

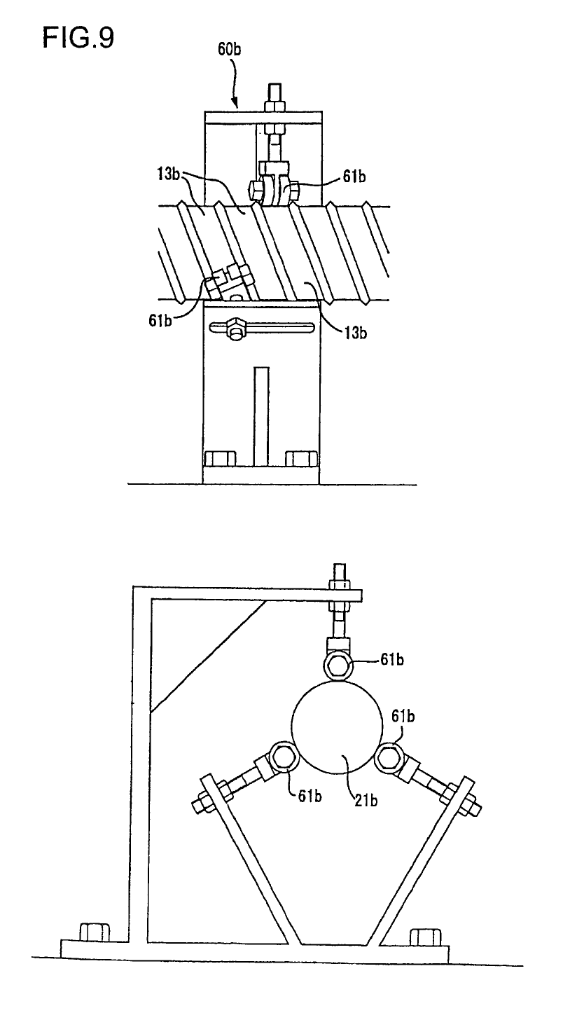

Moreover, when the handle 31b in the rotation section 30b is rotated, the fused overlapped portion 13b is sent to the member delivery section 60b shown in FIG. 9, and pressed by the pressing roller 61b to be completely welded. At this time, air may be sprayed onto the overlapped portion 13b to cool this portion, to thereby accelerate curing thereof.

When the handle 31b in the rotation section 30b is further rotated, the pressing roller 61b in the member delivery section 60b rotates together with its rotation, to thereby send the cured portion ahead sequentially away from the core 21b.

By repeating this, a sheath tube having a desired length can be obtained. As in the first embodiment, the core 21b in the wrapping section 20b is replaceable, and by replacing it with a core having another diameter, a sheath tube having a desired inner diameter can be manufactured.

### INDUSTRIAL APPLICABILITY

As described above, a sheath tube having a desired length can be easily manufactured, by spirally wrapping a ribbon-like member supplied at a predetermined angle, with the end portion thereof being overlapped, and by welding the overlapped portion.

Even in the case where a sheath tube having a different diameter size is manufactured, it is only necessary to replace the core connected by a flange joint with a core having a desired inner diameter, and change the angle of the member supply section 40b so that the end of the ribbon-like member is overlapped. This core needs only to be cylindrical, and complicated machining such as undulating is not necessary.

Moreover, since a seamless sheath tube having a desired length can be manufactured, steps such as joining tubes, reinforcing of this joining portion, and the like can be omitted, thereby improving the workability.

In addition, the width of the ribbon-like member to be used does not depend on the inner diameter of the manufactured sheath tube, and hence it is possible to manufacture sheath tubes having various diameters with one kind of ribbon-like member. If it is wrapped on a drum or the like, transportation and storage become easy. It is also possible to manufacture the sheath tube at the site where it is actually used, and hence it is not necessary to transport lengthy tubes.

Furthermore, by making the ribbon-like member for preparing the sheath tube transparent or semi-transparent, the inside of the tube can be seen from outside, after preparing the sheath tube, and hence there is the effect that quality control and inspection can be performed easily.

1. A sheath tube formed in a cylindrical shape, in such a manner that a single ribbon-like member having a predetermined width is wrapped spirally, with the end thereof overlapped, and said overlapped portion is welded.

2. A sheath tube according to claim 1, wherein said ribbon-like member has at least two walls provided parallel with the longitudinal direction thereof, and is wrapped spirally, with the outside end portions of the walls overlapped, and the overlapped portion between said walls are welded, to be formed in a cylindrical shape.

3. A sheath tube according to either one of claim 1 and claim 2, wherein said ribbon-like member is formed of a thermoplastic synthetic resin.

4. A sheath tube according to claim 3, wherein said thermoplastic synthetic resin is transparent or semi-transparent.

5. A sheath tube manufacturing method wherein a single ribbon-like member having a predetermined width is wrapped spirally, with the end thereof overlapped, and said overlapped portion is welded, to thereby form a sheath tube in a cylindrical shape.

6. A sheath tube manufacturing method according to claim 5, wherein said ribbon-like member has at least two walls provided parallel with the longitudinal direction thereof, and is wrapped spirally, with the outside end portions of the walls overlapped, and the overlapped portion of the outside end portions of said walls are welded, to form a sheath tube in a cylindrical shape.

7. A sheath tube manufacturing method according to either one of claim 5 and claim 6, wherein the overlapped portion of said ribbon-like member is heated and wrapped.

8. A sheath tube manufacturing method according to any one of claim 5 to claim 7, wherein said ribbon-like member is formed of a thermoplastic synthetic resin.

9. A sheath tube manufacturing method according to claim 8, wherein said thermoplastic synthetic resin is transparent or semi-transparent.

10. A sheath tube manufacturing apparatus comprising:
a wrapping section having a core for wrapping a single ribbon-like member having a predetermined width thereon;
a member supply section for supplying said ribbon-like member at a predetermined angle, so that said ribbon-like member are wrapped spirally, with the end thereof overlapped and;
a rotation section for rotating said wrapping section;
a welding section for fusing and pressing the overlapped portion of the ribbon-like member wrapped around said wrapping section; and
a member delivery section for pressing the fused overlapped portion and delivering it from said core.

11. A sheath tube manufacturing apparatus according to claim 10, wherein said member supply section is provided with heating means for heating the whole wrapped portion of the ribbon-like member, when said ribbon-like member is wrapped around said wrapping section.

12. A sheath tube manufacturing apparatus according to either one of claim 10 and claim 11, wherein said ribbon-like member is formed of a thermoplastic synthetic resin.

13. A sheath tube manufacturing apparatus according to claim 12, wherein said thermoplastic synthetic resin is transparent or semi-transparent.
